(19) United States
(12) Patent Application Publication
(10) Pub. No.: US 2006/0161433 A1
(43) Pub. Date: Jul. 20, 2006

(54) Codec-dependent unit selection for mobile devices

(75) Inventors: Michael Edgington, Bridgewater, MA (US); Laurence S. Gillick, Newton, MA (US); Igor Zlokarnik, Natick, MA (US)

Correspondence Address: WILMER CUTLER PICKERING HALE AND DORR LLP, 60 STATE STREET, BOSTON, MA, 02109, US

(73) Assignee: Voice Signal Technologies, Inc., Woburn, MA (US)

(21) Appl. No.: 11/262,482

(22) Filed: Oct. 28, 2005

Related U.S. Application Data
(60) Provisional application No. 60/622,838, filed on Oct. 28, 2004.

(51) Int. Cl. G10L 15/08

(52) U.S. Cl. 704/240

(57) ABSTRACT

A method of extracting a subset of speech units from a larger set of speech units for use by a speech synthesizer in synthesizing speech, wherein the speech units are stored in a compressed encoded representation that was generated by a codec, the method comprising: selecting members of the subset of speech units based on an overall cost associated with using the speech synthesizer to synthesize a test set of speech, wherein the overall cost includes at least one error introduced by using the codec to decode the stored representations of the speech units; and storing the selected subset of speech units on a speech-enabled device.

This application claims the benefit of U.S. Provisional Application No. 60/622,838, filed Oct. 28, 2004, and incorporated herein by reference.

### TECHNICAL FIELD OF THE INVENTION

This invention relates to speech synthesis, embedded software, and mobile devices.

### BACKGROUND

Speech synthesizers are used to transform text into speech. Modern speech synthesis systems are designed using “unit selection”, where short snippets of speech are selected from a database of utterances of a speaker or speakers. The snippets may then be reassembled using an algorithm to approximately recreate the sound of any particular word or utterance in the language. Classical unit selection depends on two cost functions, one, called the target cost, for the differences between features associated with a sound in a word and the relevant features of the synthesized sound in that word, and a second cost called the continuity cost, associated with the weighted sum of the differences of features at the junctures of the selected units in synthesized utterances. Units are selected so that the synthesizer database contains units that minimize these two costs, measured over a training set, and given a dictionary size, synthesis rules, and weights for the two cost functions.

### SUMMARY

The described embodiment has one or more of the following advantages. The described methods take into account the effect of distortion of synthesized units introduced by compression of the units by a vocoder. The described approach chooses a small subset of units for a small footprint synthesizer, basing the selection not only on the target cost and continuity cost from the training set, but also on an analysis of the fidelity of the acoustic signal reproduced by the codec.

In general, in one aspect, the invention features a method of extracting a subset of speech units from a larger set of speech units for use by a speech synthesizer in synthesizing speech when the speech units are stored in a compressed encoded representation that was generated by a codec. The method involves: selecting members of the subset of speech units based on an overall cost associated with using the speech synthesizer to synthesize a test set of speech, wherein the overall cost includes an error introduced by using the codec to decode the stored representations of the speech units; and storing the selected subset of speech units on a speech-enabled device.

Other embodiments include one or more of the following features. For each member of a plurality of members of the larger set of speech units, the overall cost associated with using the speech synthesizer to synthesize the test set of speech from a population of speech units that excludes that member is computed. Speech units are selected based on the overall costs computed for the plurality of members. The error introduced by the codec includes at least one of an error associated with decoding individual stored representations of the speech units and an error associated with a continuity between successive decoded stored representations of the speech units. The overall cost includes a weighted sum of a target cost, a continuity cost, and an error introduced by using the codec to decode the stored representations of the speech units. Selecting the weights involves optimizing a quality of the synthesized test set of speech by minimizing the overall cost as defined by the selected weights. Determining the quality of the synthesized set involves at least one of an empirical comparison of the synthesized speech with the original test set by a human listener and an objective comparison. Some systems pre-assign speech units to clusters based on linguistic features of the speech unit. In such systems, a method of selecting the subset of units involves selecting at least one unit from each cluster. Selecting the units from within a cluster is based at least in part on a measure of how well the unit represents the cluster acoustically. Determining the size of the extracted subset of speech units depends on a storage constraint on the device on which the speech synthesizer resides.

### BRIEF DESCRIPTION OF THE FIGURES

FIG. 1 is a flow diagram showing an algorithm for selecting a subset of units from a set of units, taking into account the effect of the vocoder.

FIG. 2 shows a high-level block diagram of a mobile phone incorporating a speech synthesizer.

### DETAILED DESCRIPTION

As described above, traditional methods of designing a large vocabulary unit-selection speech synthesizer are based on the minimization of error in speech synthesis systems that store uncompressed speech snippets. The error is composed of two parts: target cost and continuity cost. Target cost corresponds to the mismatch between the snippet sounds and the sounds of the target word fragments that the snippet is attempting to match. The target cost C¹ for using speech unit uᵢ to synthesize a target speech fragment tᵢ can be defined as the weighted sum of differences of relevant features:

$${C}^{t} ( {t}_{i} , {u}_{i} ) = {\sum }_{j = 1}^{p} {w}_{j}^{t} {C}_{j}^{t} ( {t}_{i} , {u}_{i} ) .$$

The relevant features include phonetic, metrical, and prosodic context. The continuity cost represents mismatches occurring at the joins between successive snippets:

$${C}^{c} ( {u}_{i - 1} , {u}_{i} ) = {\sum }_{k = 1}^{q} {w}_{k}^{c} {C}_{k}^{c} ( {u}_{i - 1} , {u}_{i} ) .$$

Traditional methods of unit selection select the units that minimize the sum of the target cost and the continuity costs. This process is described in Black, A. (2002) Perfect Synthesis for all of the people all of the time, Keynote, IEEE TTS Workshop 2002, Santa Monica, Calif., http://www.cs.cmu.edu/˜awb/papers/IEEE2002/allthetime/node1.html, which is incorporated herein in its entirety.

The units correspond to any speech fragment that can be concatenated to synthesize speech. Typically, units are half-phones or a multiple of half-phones.

Some speech-enabled devices, such as mobile computers, digital cell phones, or PDAs, impose stringent storage limits on resident applications. Small footprint synthesizers are required for such mobile devices. To meet these constraints, speech synthesizers use speech snippets that are compressed using a lossy compression scheme that reduces the fidelity of snippet synthesis. In these systems, the particular coding scheme for the stored speech can affect the intelligibility of the resultant synthesized speech, as the codings are non-linear and affect different speakers in different ways.

The described embodiment enhances the selection of compressed snippets for a small footprint synthesis system by including the effect of the compression on the synthesized speech in sub-selecting the units from a large vocabulary unit-selection speech synthesizer. Compression affects both target and continuity costs. The encoder cost described below refers to encoder impact on the target cost. Also described below is a further enhancement in which the encoder impact on continuity cost is considered.

Standard methods of optimizing the functionality within a limited footprint involve compression of the speech snippets using a resident codec, such as the Enhanced Variable Rate Codec (EVRC) as specified by the TIA/EIA/IS-127 Interim Standard of January 1997, which is incorporated herein in its entirety. In such systems, the synthesized speech is subject not only to errors corresponding to the target cost and the continuity cost, but also to errors introduced by the imperfections of the codec compression and decompression. These errors can interact in a non-linear fashion with the target and continuity costs to produce a significant impact on the intelligibility of synthesized speech.

Speech synthesizers typically work with a set of a few tens or hundreds of thousands of speech units. The storage constraints of mobile digital devices often require that this set be reduced by a factor of ten or more, to only a few thousand units. This radical pruning of units makes it critical that the remaining units optimally represent the speech to be synthesized in the actual operating environment in which codec-induced distortion affects the synthesized speech.

In order to optimize the selection of snippets with respect to the actual codec-processed speech heard by a user, a third error, called the encoder cost, is introduced. The encoder cost takes account of the codec-induced distortions. A method of determining the encoder cost is described below.

In the described embodiment the overall cost for synthesizing the training set using a particular unit subset is the weighted sum of all three component costs: the traditional target and continuity costs, and the new component—the encoder cost:
C=wₜ*C^{t}+w_{c}*C^{c}+Wₑ*C^{e}

Minimizing the overall cost in order to select the optimal subset of units represents a compromise between the three component costs. The system trades off local phonetic accuracy (low target cost), smoothness (low continuity cost), and good representation by the vocoder (low encoder cost).

Each component cost is typically formulated separately and may itself be a weighted sum of costs. For example, the target cost can be expressed in terms of a weighted sum of costs introduced by relevant features of speech, such as phonetic, metrical, and prosodic context. The encoder cost may be approximated to the encoder's internal measurement of coding error, which it determines as follows. For each frame, the encoder takes measurements of the speech signal in several dimensions in acoustic space, models these with a set of parameters for the encoder's speech model, and then stores a quantized representation of these parameters. The parameters are chosen by using an analysis-by-synthesis procedure in which the speech synthesized using the parameters is compared to the natural speech and an error is computed. The model parameters are adjusted until this error is reduced to an acceptable level. Thus an explicit error measure of the difference between the codec's model prediction and the natural speech is available in the form of the codec internal error measure.

In an alternative approach, the system computes the model parameters directly and quantizes them in order to represent them efficiently in the bitstream. The system typically quantizes the set of parameters by comparing the parameters to predetermined sets of parameter values, each of which is represented by a unique codeword. The system picks the predetermined set of parameters closest to the computed model parameters and determines an error between the computed parameters and the selected predetermined (i.e., quantized) set of parameters. This error is a measure of the quantization error, and can also be used to estimate the encoder cost.

The system uses empirical or objective approaches to determine the weights wₜ, w_{c}, and wₑ. The empirical approach uses judgments by human subjects about the quality of the speech. For example, one or more skilled listeners, such as the system developers themselves, adjust weights manually to determine what setting sounds best. In a more controlled subjective evaluation, a set of listeners are given speech stimuli and asked to make a scaled quality judgment. This approach might not be practical for searching a large space of potential weights, but can be used when choosing amongst a small set of candidate configurations for a system. The optimal set of weights is that which causes the system to synthesize the “best” sounding speech when it minimizes overall cost as defined by the optimally weighted sum of the three component costs.

The objective approach uses a perceptually motivated measurement of speech quality that compares the synthesized speech with the natural speech. In one example, a system calculates the Mel-scaled cepstral coefficient (MFCC) for every frame of the natural and synthesized utterances so that the boundaries align, and determines the root mean square difference between the MFCC vectors.

Inclusion of the encoder cost in the error estimation will, in general, cause a different set of snippets to be selected for each codec. Thus a CDMA phone device will have an optimized speech synthesizer consisting of a different subset of snippets from those selected for a GSM phone, since the two phones use different codecs. In each case, the intelligibility of the synthesizer will be subjected to the described optimization process, given the training set, footprint constraints, and the specified codec.

Put another way, the selection of snippets is responsive to the codec's impact on different kinds of speech. For example, if a particular codec represents a certain kind of speech poorly, the optimized system allocates more units to cover this kind of speech so as to compensate for the codec's shortcomings. Conversely, other types of speech that are well represented by the codec will be allocated fewer units.

The unit selection process can be further enhanced by including in the overall cost a continuity cost component that also takes into account the performance of the codec:
C=Wₜ*C^{t}+W_{ce}*C^{ce}+Wₑ*C^{e}.

All codecs of interest use the inherent correlation between consecutive frames of speech to reduce the amount of information that needs to be represented in the encoded bitstream. If the codec's measurement of correlation between frames is high at the first frame of a specific unit, un, then the overall system will be sensitive to any change between the acoustic details of the original context (the preceding unit uₙ₋₁) and any other candidate uₘ. The measured correlation in the original context and the difference in acoustic features between the original context and the new candidate context provides an estimate of the contiguity cost between any arbitrary pair of units in the inventory. For example, consider a speech utterance in the training set: “the cat.” If speech units correspond to half phones, then the codec would measure a high degree of correlation between the two successive units from the “e” sound in “the.” By contrast, there is a big change between the two successive units representing the second half of the “e” sound and the first part of the “c” sound at the beginning of “cat”, so the codec would measure a low correlation. The degree of correlation will be implicitly represented in the encoded bitstream for the second unit of each pair. During synthesis, the codec maintains the assumption of high correlation for the first pair, so that any difference between the original unit for the first part of “e”, and a new unit in the reduced inventory, has a large effect on the subsequent unit, i.e. the second part of the “e” sound. Where the codec expects low correlation, as in the latter pair, the differences have a more localized effect in the first of the pair. Therefore the quality of the synthesized speech is less sensitive to differences between the original context and synthetic context when the codec is anticipating a larger discontinuity.

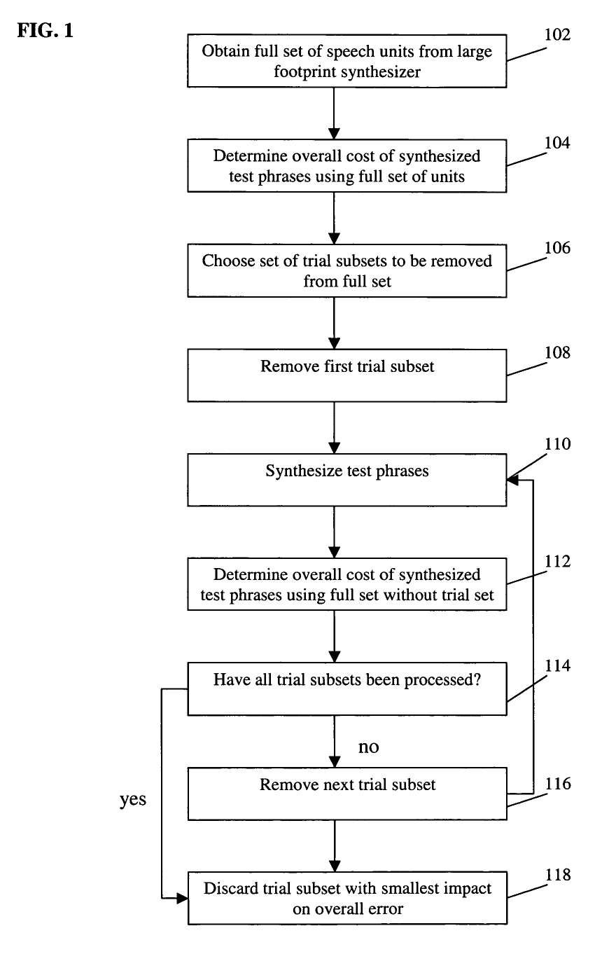

The optimal subset of speech units is selected from the population of speech units as illustrated in FIG. 1. The system obtains the full set of speech units from a large footprint synthesizer (102) and determines the overall cost of synthesizing a set of test phrases (104). In general the test phrases will be different from the training set and natural speech will not be available for the test phrases. The optimization process uses test phrases that correspond as closely as possible to the body of speech that the speech synthesizer is expected to be called upon to synthesize. The system determines what trial subsets to eliminate (106) in the selection process, as described below. The trial subsets can be individual speech units, but the number of iterations in the process can be reduced if more than one unit is eliminated in each trial subset. According to one heuristic, such acceleration of the optimization process is especially effective when the elements of the trial subset include syllable or word-length sequences of units that appear contiguously in the training set.

The unit selection process proceeds by removing the first trial subset (108), synthesizing test phrases using the remaining units (110), and determining the overall cost of the synthesized test phrases (112) as described above. The process is repeated, each time omitting a different trial subset from the set of speech units (114, 116), synthesizing the test phrases, and determining the overall cost. The trial subset which, when omitted, make the smallest contribution to the increase in overall cost is discarded (118). The above steps are repeated, each iteration reducing the size of the remaining set of speech units, until the remaining speech units fit within the imposed storage footprint limit. Typically this limit corresponds to an allocation of memory on a speech-enabled mobile device. This subset of units is the optimal subset since it makes the largest contributions to overall cost reduction.

An alternative approach makes use of clustering analysis. Many large vocabulary speech synthesizers employ clusters while synthesizing speech in real time in order to reduce the unit search space based on the speech's linguistic context. An illustrative clustering technique is described in M. W. Macon, A. E. Cronk, and J. Wouters, Generalization and discrimination in tree-structured unit selection, in Proceedings of the 3rd ESCA/COCOSDA International Speech Synthesis Workshop, November 1998, and in Hunt, A. J. and Black, A. W., Unit Selection in a Concatenative Speech Synthesis System Using a Large Speech Database, in Proc. ICASSP-96, May 7-10, Atlanta, Ga., which are incorporated herein in their entirety. In cluster analysis, a speech unit is pre-classified and placed into a cluster with other units that have similar linguistic features. Linguistic features are features that are derived from the text, such as the phoneme sequence, lexical stress, syllable structure, proximity to the start/end of the current phrase, the likelihood of significant pitch movement in the syllable, and utterance type (such as a question or a statement). Clusters are linked by decision trees that determine cluster sequence probabilities. For example, a single cluster might be used for the first half of all primary stressed “ee” sounds when followed by a nasal, preceded by a “t” and not in the last word of a phrase. When using clusters, a synthesizer determines the subsequent cluster using the decision tree. The synthesizer searches for the best unit only within that subsequent cluster. Since only a small fraction of the available units lie within a given cluster, the search space is radically pruned.

Since cluster analysis places similar units within the same cluster, an effective unit selection approach is to use clusters as the “first cut” for selecting units for the small footprint synthesizer by selecting at least one representative unit from each cluster. To determine which units within a cluster best represent the cluster, the system evaluates the cluster units acoustically using, for example, their MFCC, and discards the acoustic outliers. The remaining units are then evaluated against the applicable codec and their encoder cost is determined. Units within each cluster are then selected based on an overall utility parameter that is a combination of their encoder cost and of how well they represent the cluster acoustically.

A minimum of one unit from each cluster is selected, but more can be selected until the footprint constraints are reached. In one approach, the number of units selected from a given cluster depends on the frequency that the cluster is selected over a representative set of test phrases.

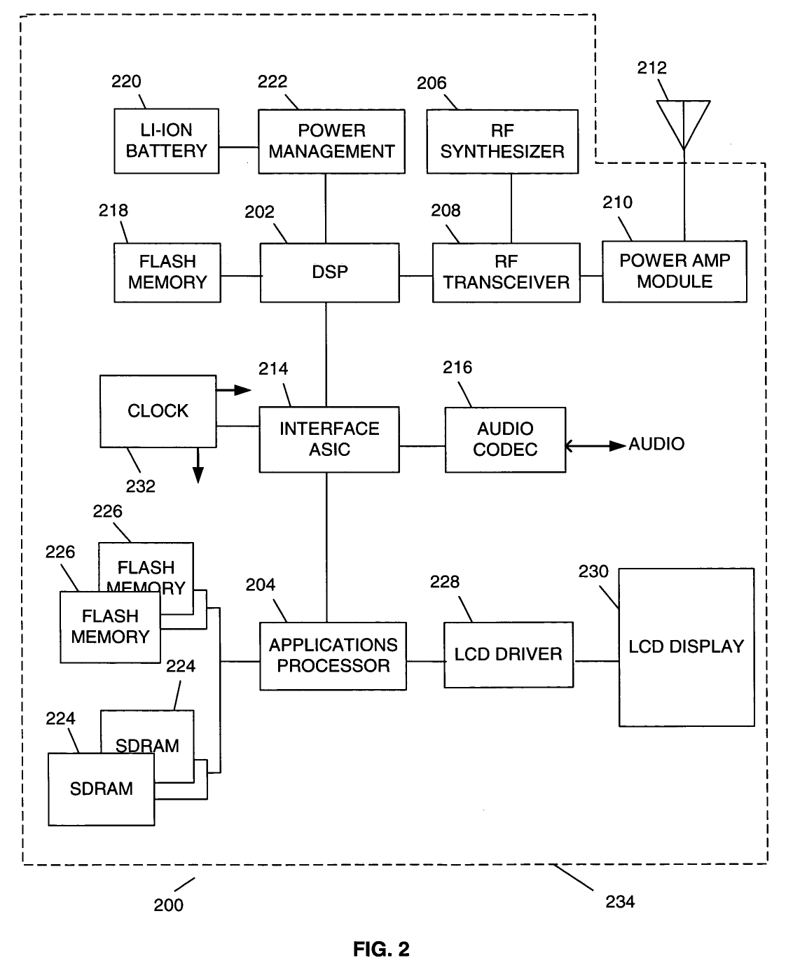

In the described embodiment, the speech-enabled device is a cellular phone 200, such as is illustrated by the high-level functional block diagram of FIG. 2. The phone 200 is a Microsoft PocketPC-powered phone which includes at its core a baseband DSP 202 (digital signal processor) for handling the cellular communication functions (including for example voiceband and channel coding functions) and an applications processor 204 (e.g., Intel StrongArm SA-1110) on which the PocketPC operating system runs. The phone supports various applications, such as GSM voice calls, SMS (Short Messaging Service) text messaging, wireless email, and desktop-like web browsing along with more traditional PDA features.

The transmit and receive functions are implemented by an RF synthesizer 206 and an RF radio transceiver 208 followed by a power amplifier module 210 that handles the final-stage RF transmit duties through an antenna 212. An interface ASIC (application-specific integrated circuit) 214 and an audio Codec 216 provide interfaces to a speaker, a microphone, and other input/output devices provided in the phone such as a numeric or alphanumeric keypad (not shown) for entering commands and information. DSP 202 uses a flash memory 218 for code store. A Li-Ion (lithium-ion) battery 220 powers the phone and a power management module 222 coupled to DSP 202 manages power consumption within the phone. Volatile and non-volatile memory for applications processor 204 is provided in the form of SDRAM 224 and flash memory 226, respectively. This arrangement of memory is used to hold the code for the operating system, the code for customizable features such as the phone directory, and the code for any applications software that might be included in the phone, including the compressed speech units and speech synthesizer described above.

The visual display device for the phone includes an LCD driver chip 228 that drives an LCD display 230. There is also a clock module 232 that provides the clock signals for the other devices within the phone and provides an indicator of real time.

All of the above-described components are packaged within an appropriately designed housing 234. Since the phone described above is representative of the general internal structure of a number of different commercially available phones and since the internal circuit design of those phones is generally known to persons of ordinary skill in this art, further details about the components shown in FIG. 2 and their operation are not being provided and are not necessary to understanding the invention.

In general, the speech enabled device would not have to be a cellular phone at all, but would possess the functionality of synthesizing speech from an internally stored coded set of speech units, decoding the speech units, and synthesizing speech from the units. For example a laptop computer or PDA having a speaker, and appropriate software to generate speech from speech units, or any other device with similar functionality, could also be implemented.

Other aspects, modifications, and embodiments are within the scope of the following claims.

What is claimed is:

1. A method of extracting a subset of speech units from a larger set of speech units for use by a codec in combination with a speech synthesizer in synthesizing speech, the method comprising:
from the larger set of speech units, selecting members of the subset of speech units based in part on a cost measure associated with using the codec; and
storing the selected subset of speech units on a speech-enabled device.

2. The method of claim 17, wherein selecting comprises:
for each member of a plurality of members of the set of speech units, computing the overall cost associated with using the speech synthesizer to synthesize the test set of speech from a population of speech units that excludes that member; and
from the larger set of speech units, selecting the speech units that are members of the subset of speech units based upon the overall costs computed for the plurality of members.

3. The method of claim 17, wherein the cost measure associated with using the codec is a measure of an error associated with decoding individual stored representations of the speech units.

4. The method of claim 17, wherein the cost measure associated with using the codec is a measure of an error associated with the codec's impact on a continuity between successive decoded stored representations of the speech units.

5. The method of claim 17, wherein the overall cost comprises a weighted sum of a target cost and a continuity cost, and the cost associated with using the codec is a measure of an error associated with decoding individual stored representations of the speech units.

6. The method of claim 5, wherein the weights are selected to optimize a quality of the synthesized test set when the overall cost as defined by the selected weights is minimized.

7. The method of claim 6 wherein the quality of the synthesized test set is empirically determined by at least one listener.

8. The method of claim 6, wherein the quality of the synthesized test set is determined by an objective comparison of the synthesized test set with the original test set.

9. The method of claim 17, wherein the overall cost comprises a weighted sum of a target cost and a continuity cost, and the cost associated with using the codec is a measure of an error associated with the codec's impact on a continuity between adjacent decoded speech units.

10. The method of claim 9, wherein the weights are selected to optimize a quality of the synthesized test set when the overall cost as defined by the selected weights is minimized.

11. The method of claim 10, wherein the quality of the synthesized test set is empirically determined by at least one listener.

12. The method of claim 10, wherein the quality of the synthesized test set is determined by an objective comparison of the synthesized test set with the original test set.

13. The method of claim 1, wherein each speech unit is pre-assigned to a cluster by a cluster analysis process, the assignment being based on at least one linguistic feature of the speech unit.

14. The method of claim 13, wherein the subset of speech units comprises at least one unit selected from each cluster.

15. The method of claim 14, wherein the overall cost used to perform the selection of the at least one unit from each cluster is further based at least in part on a measure of how well the unit represents the cluster acoustically.

16. The method of claim 1, wherein a number of units in the subset of speech units is determined at least in part by a storage constraint of the speech-enabled device.

17. The method of claim 1, wherein selecting members of the subset of speech units based on an overall cost associated with using the speech synthesizer to synthesize a test set of speech, wherein the overall cost includes the cost measure associated with using the codec to decode the stored representations of the speech units.
